(19) United States
(12) Patent Application Publication
(10) Pub. No.: US 2016/0071546 A1
(43) Pub. Date: Mar. 10, 2016

(54) Method of Active-View Movie Technology for Creating and Playing Multi-Stream Video Files

(71) Applicants: Lev NEYMOTIN, Plainview, NY (US); Barak Eliezer SPEISER, Plainview, NY (US)

(72) Inventors: Lev NEYMOTIN, Plainview, NY (US); Barak Eliezer SPEISER, Plainview, NY (US)

(21) Appl. No.: 14/476,839

(22) Filed: Sep. 4, 2014

(51) Int. Cl. G11B 27/036; H04N 9/87; H04N 5/265

(52) U.S. Cl. CPC G11B 27/036; H04N 5/265; H04N 9/87

(57) ABSTRACT

A method for creating an interactive movie or video is disclosed. The interactive video method involves producing a new video format incorporating multiple selectable video channels of interconnected content, thereby enabling viewers to create their own personalized viewing experience. The multiple streams of video are incorporated into a single multi-channel video stream readable by a claimed player software that makes them available to a viewer on various viewing platforms such as Oculus Rift™ Virtual Reality (VR) Headset.

This application is the United States Non-provisional application, which claims the benefit of U.S. Provisional Patent application No. 62/016,507 Filed Jun. 24, 2014, the entire disclosure of which is incorporated herein by reference.

This invention relates to:

The invention applies to the field of producing narrative and documentary movies, training/educational videos, medical/therapeutic applications, and advertisement videos. It also relates to design of video processing computer applications. The invention also applies to production of multi-channel video files carrying multiple simultaneous video streams available for viewing at different platforms.

### BACKGROUND

Movies and videos are constantly evolving, immersive experiences. Over the years, the art of film has developed greatly, with new elements gradually being introduced: Sound, color, 3D and most recently, 360-degree movies using a Virtual Reality (VR) headset device.

With all its evolution and development, one fundamental aspect of film remains stagnant: Film is a passive experience. A viewer is taken “on a journey”, one which he or she has no input nor participation in. Although viewers are captivated by filmmakers' evolving designs, no attempt to transform the movie-watching experience into an interactive one has been made to date. Even the budding VR movies (the first of which, a documentary, will soon be released for the Oculus Rift™ VR Headset) are at the time of claiming the enclosed invention, no more than a utilization of the 360° Camera for a 360° viewing experience. The participation in a 360°/VR movie is limited only to the ability to look around a scene or setting, while the passive nature in following the movie's narrative remains the same as in a conventional movie. Thus, despite the new possibilities a 360° field of vision provides, the passivity of the movie-viewing experience remains largely unchanged. Movies and videos are a linear, predetermined sequence. A viewer is fed a series of shots, scenes and sequences which he has no control over—he has no say as to what he is shown. As a result, the viewer is completely passive and “in the filmmakers' hands”.

And since the nature of film is a stimulation of viewers' attention and involvement in its events, viewers' non-participation is counter-productive to a film's goal. The same is true for other entertainment videos as well as video advertisements (commercials) in which the goal is to deliver a ‘message’ about a product by triggering viewer involvement with the video and the product.

In a training/educational video, a different problem is more apparent: Because such videos are a linear presentation, when a viewer wants see a certain point in the video, he/she is forced to either wait for its arrival or skip (or rewind/fast-forward) and then search for that moment. For example, in a martial arts training video, when a viewer watching a teacher's explanation of a certain technique wants to jump forward and view the technique in action, or vice versa, the viewer must now locate the exact moment on a timeline of a video, or rewind/fast-forward when using a TV or remote control.

The same is true for medical and therapeutic videos: As a linear process, when a viewer is interested in seeing specific content relating to the one seen on the screen, he must either wait or skip to his desired point. This is an obstacle in the patient's way of experiencing the healing video smoothly. In addition, as long as training, educational and medical/therapeutic videos dispense information linearly, they leave the viewer passive. As is true for all video content, their passivity reduces their impact, their effectiveness and the way in which they contribute to the viewer's life.

### SUMMARY OF THE INVENTION

It is an object of the current invention to create an interactive video. A multi-channeled video format is herein introduced and referred to as an Active-View Movie Technology, or ‘AVMT’, Video. The AVMT Video is a video in which content, such as a single story of a feature-length movie, is presented in multiple parallel interconnected video channels. The video is ‘broken down’ into a manageable number of threads all playing in parallel, and these channels are made available to the viewer at any moment by his/her selection. Instead of the single linear presentation of various events or content a classic video provides, the AVMT Video widens its spectrum to multiple threads, and leaves the viewer to build the experience. The viewer in turn changes channels throughout the video at his will, creating his own unique viewing experience—corresponding with the viewer's unique preferences or needs. An AVMT Video's channels are each dedicated to specific subjects, aspects or events; all video channels play in parallel and may include specific characters in a movie (each channel follows a different character throughout the movie), complementing content in a training video (a teacher who explains one channel, and an instructor who demonstrates on another channel), or various viewing angles on the same action. Thus the Active-View Movie Technology Video is interactive not as a video game where a user has control of the characters, or impacts the events of the story, rather, the watch at any given moment according to his requirement or preference. This interaction has different advantages in each field of implementation, the major categories of which are entertainment and education: In entertainment videos, multiple channels introduce choice and create a deeper connection between the viewer and the content since the viewer chooses who (which character) or what (what event or angle) to follow. Likewise, the viewer's connection and activeness create a more immersive experience than a classic film or entertainment video. And finally, viewers experience the video differently every time. In educational videos, multiple channels introduce a newly enhanced and enriched video: By introducing multiple channels, the viewer's ability to receive information is enhanced, since he can receive it at his own pace. If he needs to view related content—such as a live specimen of the animal of which a lecturer speaks—he needs only switch to the channel displaying it; this minimizes the need to skip to content which exists only in another specific moment in the video. In all AVMT Videos, the result is a shift in the video-watching experience, from a passive experience, to an active experience.

To create this invention, a concept is first needed. The AVMT Video begins with a script which describes the video's concept in multiple parallel channels, written in separate sections; this applies to all types of videos: Entertainment, educational or other. Each of the script's sections is then produced and edited. The multiple videos are then compiled into one file using a specialized computer program which also prepares them to be played and selected on a viewing platform. A player program is created for playing this AVMT file on a computer or other platform, the program is designed to be controlled using assorted controllers.

The first and preferred of these controllers is a Virtual Reality (VR) Headset, with which the program places the viewer in a ‘video screen environment’. The video's channels (screens) ‘surround’ the Headset's field of vision—with each screen ‘positioned’ on a different side of the Headset. As he wears the headset, the selection of screens is made with the movement of the user's head: The viewer needs only ‘look’ in a desired screen's direction to see it. This natural motion further contributes to the video screens' accessibility, and makes for a further immersive experience since it is the viewer's intuitive glance that enables him to see a screen.

### BRIEF DESCRIPTION OF THE DRAWINGS

FIG. 1 illustrates the AVMT video making process.

FIG. 2 illustrates the relationship between video channels and script sections.

FIG. 3 illustrates an AVMT Screenplay Format.

FIGS. 4 and 5 illustrate the difference between AVMT video filming and conventional filming.

FIG. 6 illustrates a use of AVMT in advertising.

FIG. 7 illustrates a use of AVMT in a training video.

FIG. 8 illustrates an AVMT video in action, with three screens.

FIG. 9 illustrates an AVMT video's screen control when used with a VR headset (3 screens).

FIG. 10 illustrates AVMT video's screen control when used with a VR headset (2 screens).

FIG. 11 illustrates the ‘scrolling’ controls of an AVMT video.

FIG. 12 illustrates the ‘switching’ controls of an AVMT video.

FIG. 13 illustrates the output of the AVMT tracking software.

### DETAILED DESCRIPTION OF EMBODIMENTS

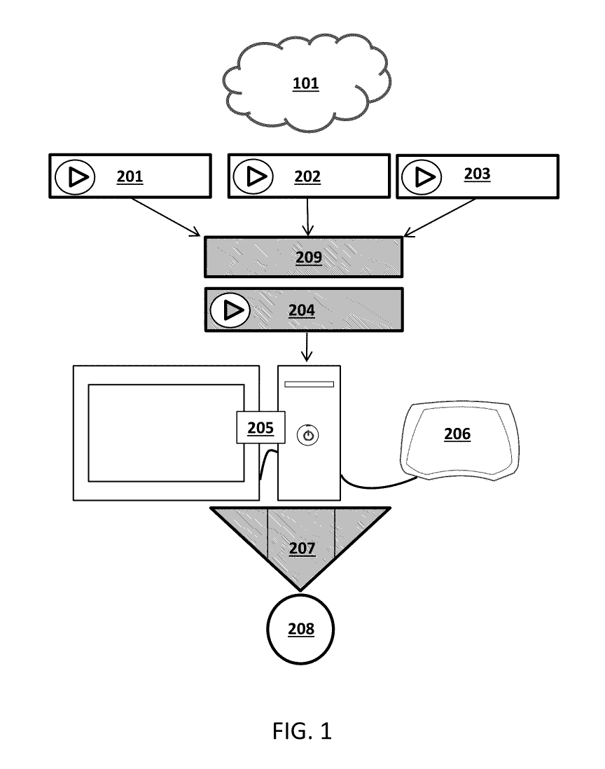

FIG. 1 illustrates the AVMT video making process, the AVMT video's translation from script to screen. The multi-sectioned script 101 is written, each corresponding video section (in this example, three) 201, 202, 203 is produced, and then processed by the AVMT Video Compiler 209, which creates an integrated AVMT Video file 204 composed of these three sections—now ready to play in parallel channels simultaneously. The AVMT file is fed to a computer 205 connected to the viewing platform 206 on which the viewer 208 plays and controls the video using the player software 207. Viewing platforms include a Virtual Reality (VR) Headset, such as the Oculus Rift™ VR Headset connected to a computer or dedicated player (hardware), a TV screen or other screen connected to a dedicated player (hardware), as well as mobile devices.

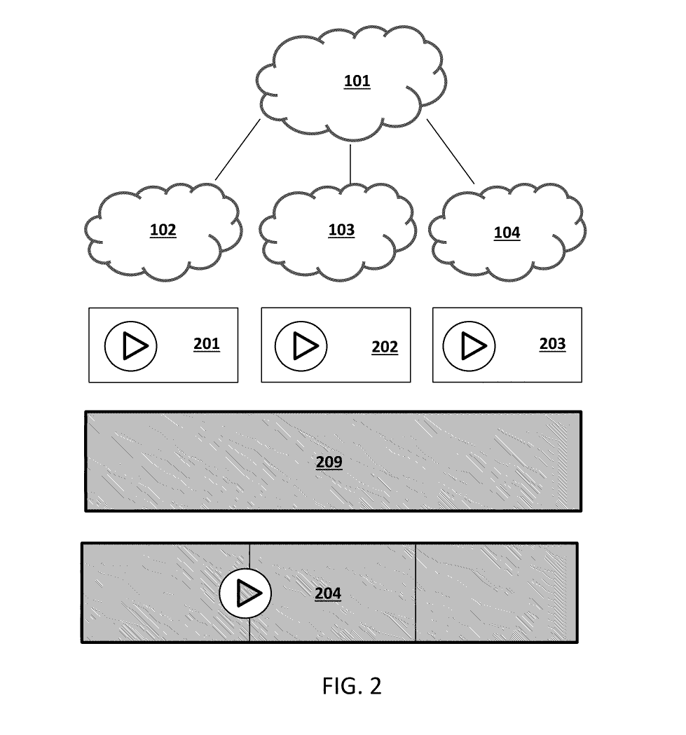

FIG. 2 illustrates the relationship between video channels 201, 202, 203 and script sections 102, 103, 104. All script sections comprise the complete AVMT Script 101. Each script section describes the entire video stream of its respective channel: script section 102 describes channel 201; script section 103 describes channel 202; script section 104 describes channel 203. All screens are compiled into one AVMT Video file 204 by the video compiler 209 and made ready to be viewed and selected on a VR headset or other device.

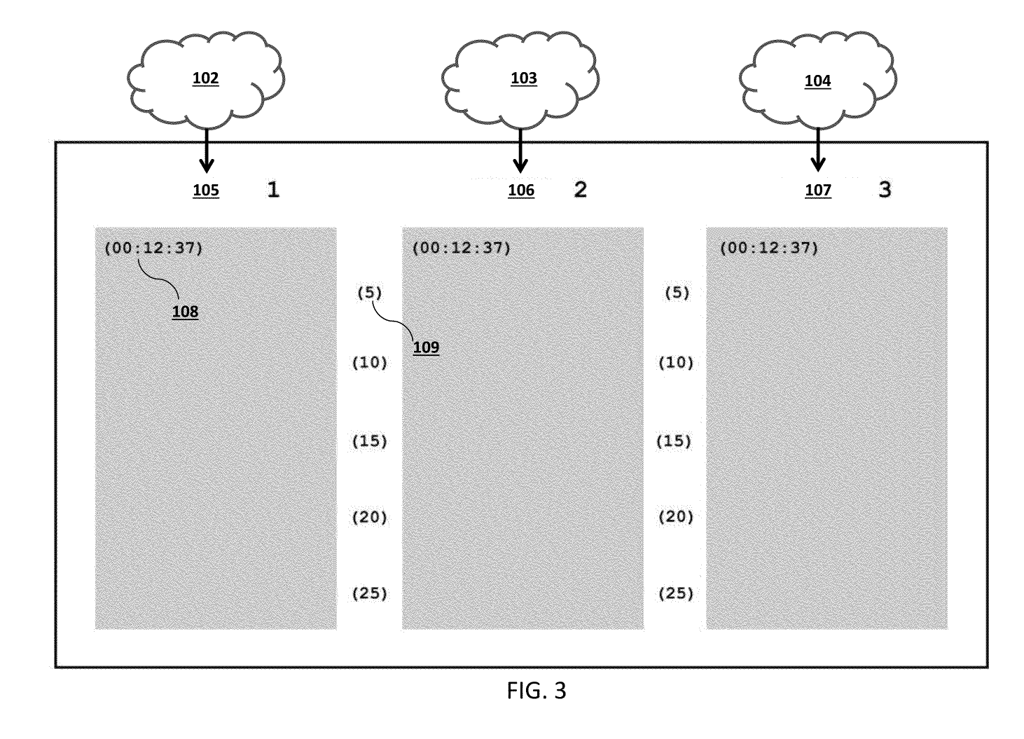

FIG. 3 illustrates an AVMT Screenplay Format. The script is divided into a number of columns (three in FIG. 3) 105, 106, 107 corresponding with the number of script sections 102, 103, 104, which will later become the channels of the AVMT video (FIG. 1). In this case, three sections and columns are shown. Scenes and special events begin with a time counter for synchronization 108 where needed. Alternately, line numbers 109 are used for this purpose, with each line number representing a common parallel timing for all sections.

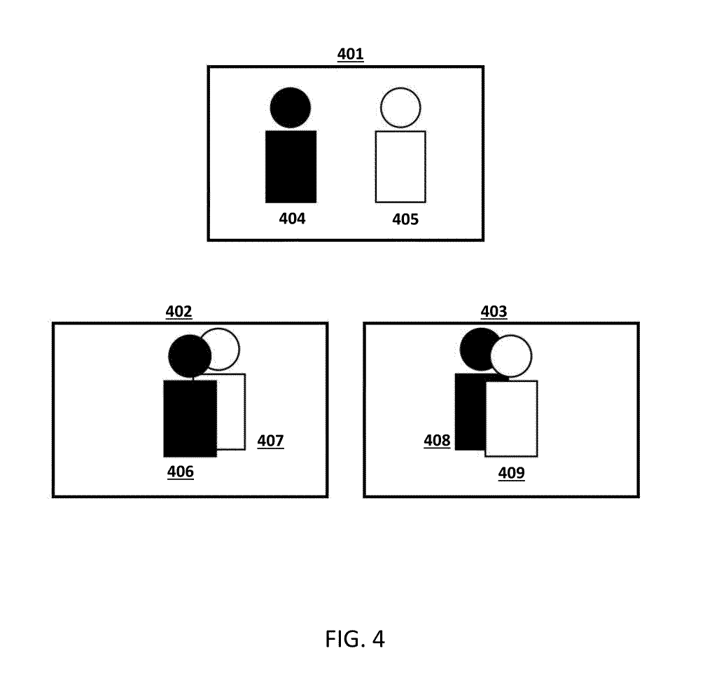

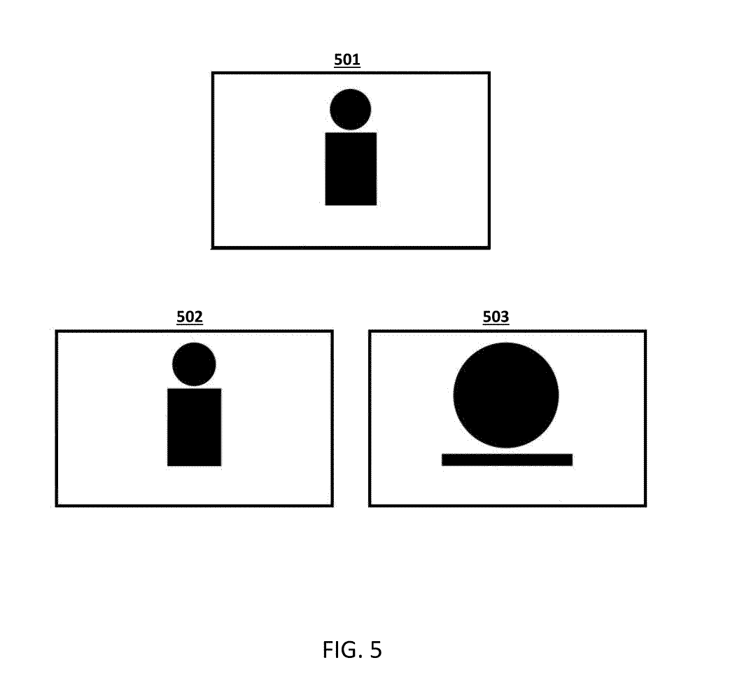

FIG. 4 and FIG. 5 illustrate the difference between AVMT video filming and conventional filming. In an AVMT movie, simplicity is maintained and therefore the same ‘two-shot’ 401 is kept throughout the entire scene. In a conventional movie, different shots are filmed and are alternated, as in FIG. 4: The two characters are filmed in interchanging shots 402, 403. In FIG. 5, the example of a static wide shot 501 vs. an interchanging close-up shot and wide shot 502, 503 expresses the same principle: Whereas a conventional film utilizes various shots for expression, an AVMT video purposely maintains simplicity, and uses one shot wherever possible.

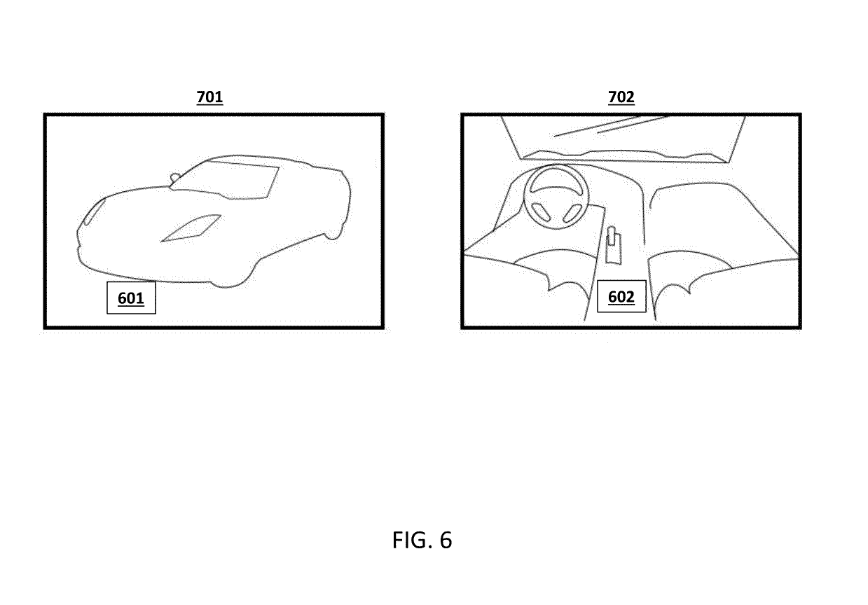

FIG. 6 illustrates a use of AVMT in advertising. The screens 701 and 702 display different viewpoints of an advertised car in video format, the first angle 601 is the outside of the car, the second angle 602 is inside the car.

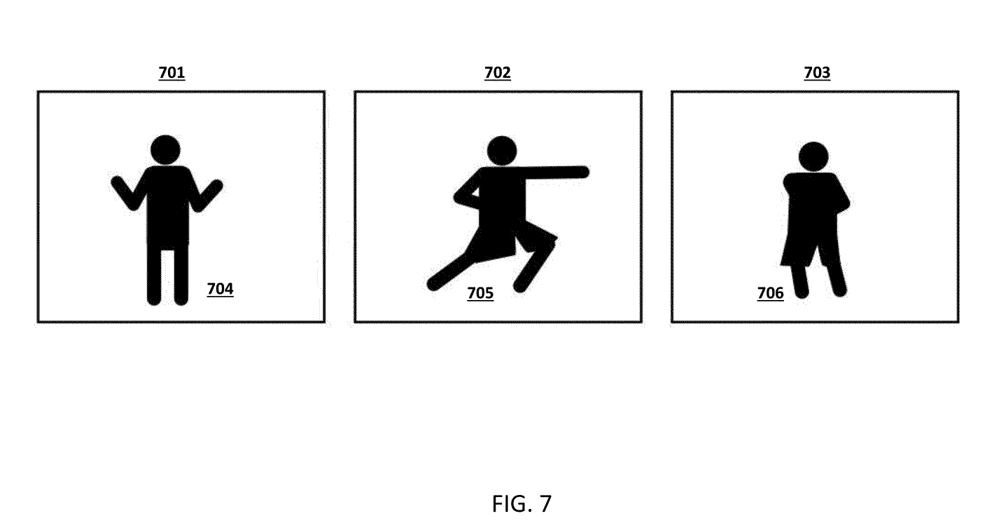

FIG. 7 illustrates a use of AVMT in a training video. In this martial arts AVMT training video, the three screens 701, 702, 703, display multiple aspects of the training simultaneously. In this way all aspects and viewpoints are readily available to the user: A guide's explanation plays on one screen 704 while two angles of demonstration 705, 706 play on another screen.

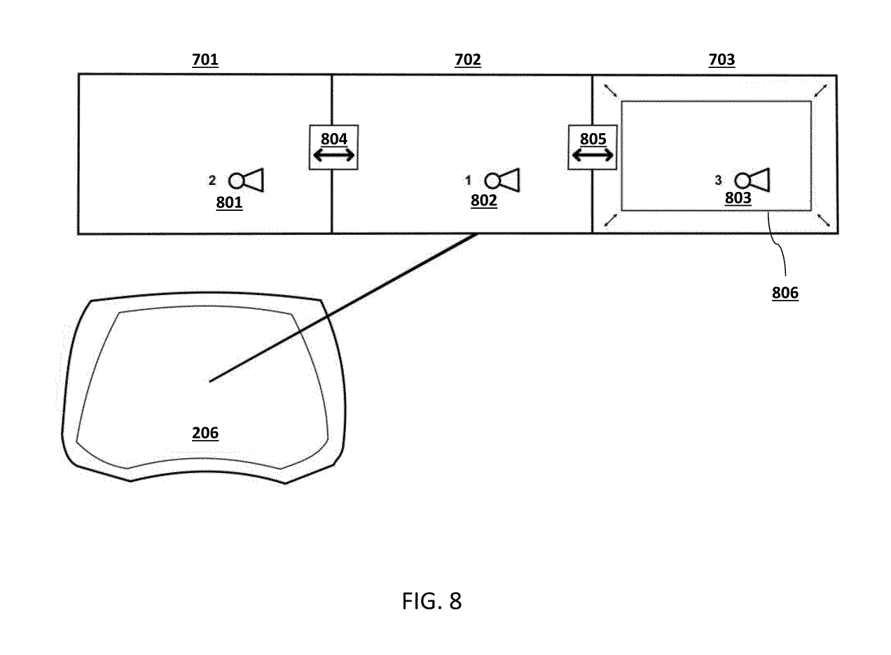

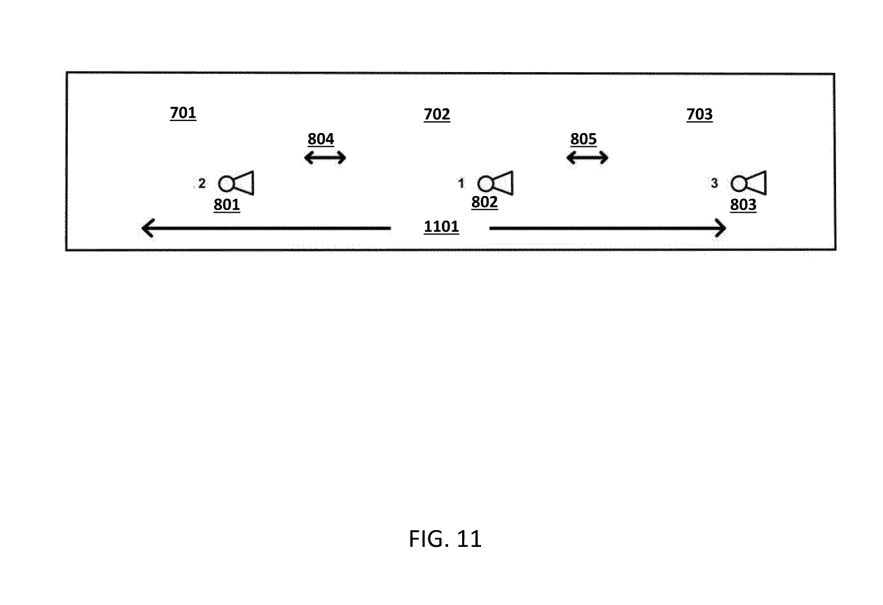

FIG. 8 illustrates an AVMT Video in action, with three screens 701, 702, 703 as an example. The VR Headset or other viewing platform 206 is selecting Screen Three 803 (as indicated by 806), to its left. In this example, to VR Headset position's right is Screen Two 701. Screen Three 703 is on its far right and Screen One 702 is in the center. The three screens, and their soundtracks 801, 802, 803 fade as the VR Headset moves between them 804, 805: From Screen Two 701 to Screen One 702 and vice versa, and from Screen One 702 to Screen Three 703 and vice versa. Alternately, a ‘Switching’ selection is enabled as a non-dynamic selecting option, as in FIG. 11. This illustration also demonstrates a situation where the viewing device's field of vision 806 is smaller than each of the three screens 701, 702, 703. This option enables the viewer to ‘look’ around within a screen, as well as select different screens.

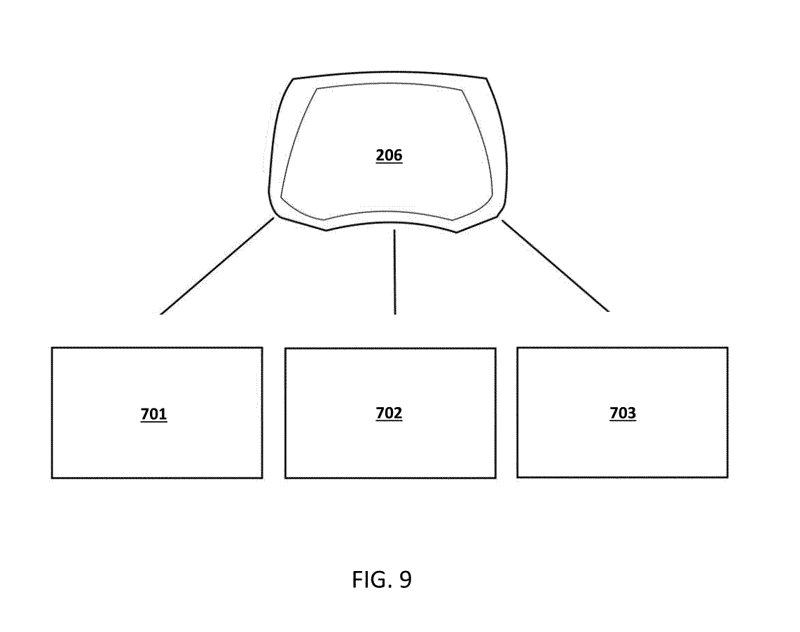

FIG. 9 illustrates an AVMT video's screen directions when used with a VR headset 206, with three screens 701, 702, 703. Screen One (headset's right) 702 is in the center and seen when the VR Headset is pointed forward, Screen Two 701 is to the right and seen when the VR Headset is pointed to the right, and Screen Three 703 is likewise to the left and seen when the headset is pointed to the left.

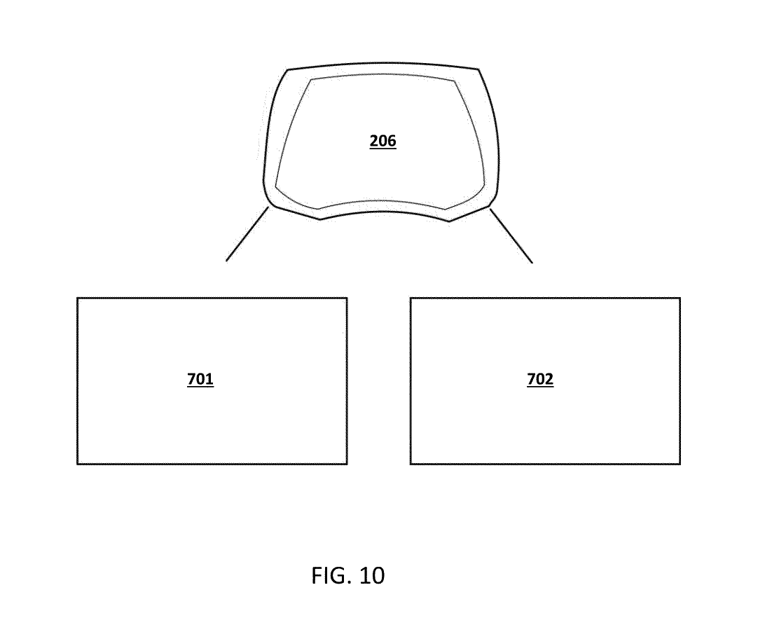

FIG. 10 illustrates video's screen directions when used with a VR headset 206, with two screens, as an example. Screen One 701 is on the right and seen when the VR headset is pointed to the right; Screen Two 702 is on the left and seen when the VR headset is pointed to the left. When ‘scrolling’ (FIG. 11), the screens fade into each other as does the sound; if the VR headset is pointed forward when scrolling is enabled, the VR Headset's vision will be split: The right half of the screen will contain half of Screen One 701, and the left half of the screen will contain half of Screen Two 702; in such a situation the sound will likewise be a combination of both screen's soundtracks.

FIG. 11 illustrates the ‘scrolling’ controls of an AVMT Video. When scrolling with a VR Headset or other controller, the user's field of view shifts linearly between the prepositioned screens 701, 702, 703; their video and soundtrack 801, 802, 803 fades between them 804, 805.

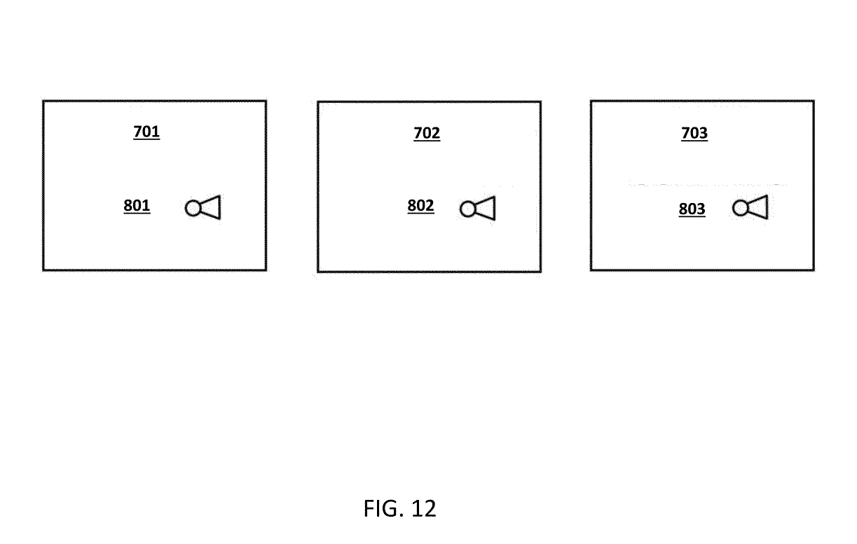

FIG. 12 illustrates the ‘switching’ controls of an AVMT Video. The video screens 701, 702, 703 and their soundtracks 801, 802, 803 switch instantaneously at a press of a button, or at a tilt of the head when using a VR Headset.

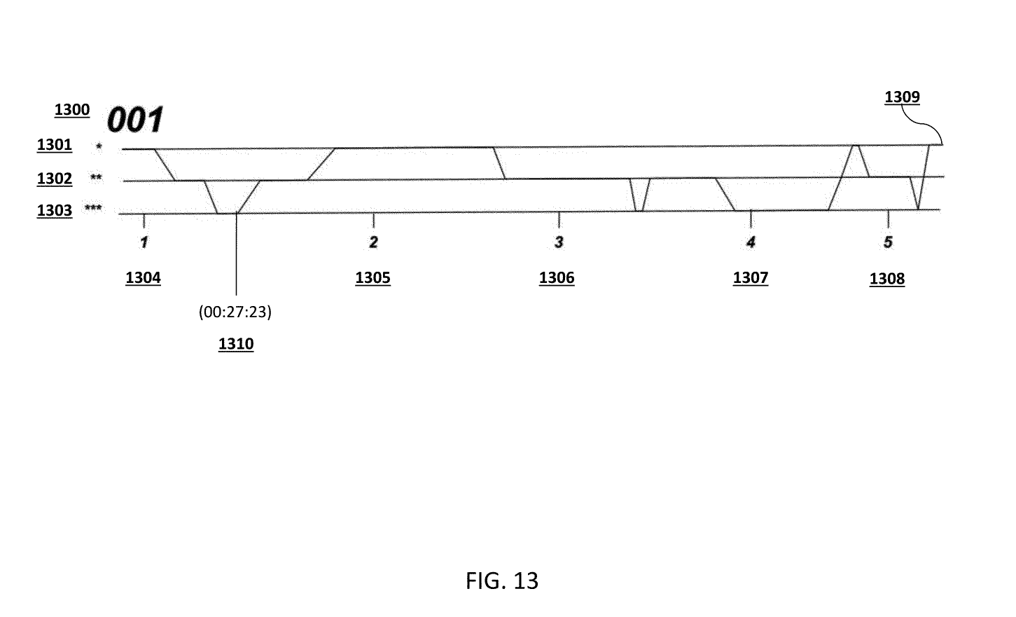

FIG. 13 illustrates the output of the AVMT viewer tracking/recording software. The software records the viewer's choices throughout the entire AVMT Video and can replay the video in the exact way in which a given user chose to view it. In addition, the software displays the entire output graphically, as in this illustration: The file name/number 1300 describes the given recording. Each of the three channels is represented by a line and is assigned a number, letter, etc. 1301, 1302, 1303 and the viewer's through line 1309 is displayed travelling throughout it. Chapter numbers 1304, 1305, 1306, 1307, 1308 are also used as a point of reference. A time counter 1310 is displayed at points of departure from a screen.

The AVMT applications include but are not limited to:
Narrative content films (including movies, TV shows, music videos and other entertainment videos);
Documentary films;
Advertising videos;
Training and educational videos;
Medical and therapeutic videos;
Each of the above in a group-viewing setting.

### Narrative Content Active-View Movie Preproduction: Screenplay

Note: This section describes preferred embodiments of AVMT through the example of narrative movies and is likewise applicable to all scripted narrative videos.

Like any movie, an Active-View Movie (AVM) begins with a script (FIG. 1 101) which is the movie's written blueprint. This script is specially written for the Active-View format (FIG. 3).

The essential difference between a conventional screenplay and a screenplay of an AVM is in its structure and content. Whereas a conventional screenplay describes interchanging characters throughout a series of scenes, an AVM screenplay describes the parallel actions of multiple characters throughout one entire movie in its multiple sections (FIG. 2, 102, 103, 104), leaving the eventual AVM viewer to decide what to view and when. Alternately, AVM screenplays consist of sections following characters interchanging with other content as well (e.g., news broadcast; related events; additional angles on one event).

An AVM screenplay supports this unique viewing experience of enabling viewers to follow multiple characters. The AVM screenplay is also designed to ‘prepare’ the viewer for the experience so that he may achieve an optimal one; this is done by gradually building up the multiple screens' content and the degree of range in the screen content. An example for this is a screenplay beginning with one character in one screen and supporting content on another screen (such as an additional angle on the same action)—a limited amount of content. The screenplay then gradually presents the viewer with a wider variety of content, an additional character followed in the additional screen, with a storyline of his own.

As the screenplay progresses, each section is designed to capture the viewer's attention on one hand, and to periodically invite shifts to other screens, on the other (an example of this invitation —characters referring to a character on another screen invites the viewer to view this character). In this way a dynamic viewing experience is ensured.

### Narrative Content Active-View Movie: Screenplay Format and Features

Since an Active-View Movie is made up of a number of screens, the movie's script must dictate each of these screen's content. Thus, an Active-View Movie's script (FIG. 1, 101) is divided into multiple sections (FIG. 3), with each section describing the content of one screen. In a video with 3 screens, the script includes 3 sections. All of these sections happen on screens in parallel and are interconnected by design. Consequently, the AVM screenplay must specify the synchronization between all sections (FIG. 3). It must describe at what point in time a given event happens on each screen, noting its timing either with time units (hours, minutes, seconds etc. as in item 108), using a more general description such as chapter names (with each chapter beginning and ending at the same time in all sections), noting specific moments which must happen in synchronization, or being written in parallel columns (item 105, 106, 107) of numbered lines 109 with each line taking place in parallel in all columns and can additionally represent a set number of seconds.
Example for use of chapters: A given Active-View Movie contains Three Screens and therefore its script contains Three Sections. Each section contains twelve chapters. These chapters are named or numbered identically in each section, and each chapter starts and ends at specific points in time. In this way, what happens in each chapter and in each section is synchronized.

A time counter (e.g., 01:20:35, one hour, twenty minutes and thirty-five seconds) can be placed at the start of each scene and/or specific points of action which must be synchronized. In some cases, a combination of some or all of the above methods is applied.

The AVM script is a modified screenplay format which specifies the unique information needed for an AVM production such as:
Screen synchronization/event timing
Screen size
Screen location
Section
Chapter name/number
Sound specifications

### Narrative Content Active-View Movie: Production

Once the script is ready, the Active-View Movie itself is produced: Each script section must be filmed, ‘translated’ from the words on the page to video and sound as in FIG. 2 102, 201; 103, 202; 104, 203. Like any movie, actors must be cast for the script's characters, locations must be scouted, crew positions assigned etc.

### Active-View Movie Shooting and Editing

A key differing point in an AVM's production compared to that of a conventional film is in the AVM's shooting and editing style FIG. 4 and FIG. 5: Whereas a conventional movie relies on frequent ‘cuts’—its footage presented piece by piece, for example: Character One is shown speaking, then the video cuts to the opposite angle to show Character Two replying, and cuts back to Character One's angle again (502, 503), in an Active-View Movie, much of the footage is shot and presented continuously FIG. 4 401, FIG. 5 501. The AVM resorts to fades or cuts between scenes and shots only where they are unavoidable, as when jumping forward or backward in time for example. If two characters are speaking, a static ‘two-shot’ (an angle including both characters at once) is utilized 401. Following the same principal, where applicable, the camera will follow its subject throughout his/her actions without skipping through them (showing a character's path from his home to the car, for example, rather than cutting to his entering the car). The goal of this style is creating the sense that the camera, and therefore the viewer, is an ever-present entity in the film. Rather than feeding selected information about the character like a conventional film does, the AVM causes the illusion that the character is really there, and it is the viewer who selects what to see.

In addition, while conventional shooting and editing jumps freely from close-up to wide shot FIG. 5, 502, 503 or to a new scene etc., AVM directing call for filming a scene in one shot wherever possible 401, 501; in a conventional film, the confusion of jumping between shots is avoided by editing the scene in a way that continuously displays its shots' context. A conversation scene, for example, will often cut from a shot of one participant to a wide shot containing all participants in order to remind viewers of the close-up shot's context. But unlike a conventional film, in an AVM a viewer would easily miss these points of reference as he selects different channels, and this would result in viewers' constant confusion upon shifting between screens and finding unintelligible content (e.g., a person's head speaking to an unknown listener is a shot which is incomprehensible when seen out of context). For these reasons, each of an AVM's sections is shot in a consistent, flowing style; a style which creates the sense of a ‘hidden camera’ going along the journey, and makes all screens easy to follow even when a shift is made between them. As this footage is shot and edited, the director and editor must keep to the screenplay's specifications of timing as illustrated in FIG. 3.

Following production, an AVM's unique post-production process includes compiling all video streams into one multi-channeled AVMT Video file. This process is described below in “Post Production”.

### Active-View Documentary Films

Documentary films generally consist of a combination of scripted and unscripted events. A conventional documentary film may begin with a rough concept or script, continue with shooting of footage—planned/scripted and otherwise, and then edited into the final version of the film. In an AVM documentary, the scripted and unscripted footage is gathered or created with the AVM screenplay format in mind. This means that more than one channel of video is available at any time, and related content can be dispensed (played) in parallel instead of edited linearly. An AVM documentary filmmaker will script and shoot additional footage with this principal in mind, since there is much more time to accommodate it. The AVM documentary is then edited accordingly; the footage, which is abundant in documentaries, is sorted, selected and then arranged in parallel channels. In each segment or chapter of the film, related content is projected on multiple screens at once. This provides the viewer with the ability to create his own viewing experience of the documentary, and also enables him to view the relating content by simply moving his head whenever necessary or desired, similarly to the educational/training videos described below.
Example: In a documentary about farming, one screen displays footage of a farmer speaking of his organic chicken coup. A second screen displays the chicken coup being tended to. As the viewer watches the farmer's exposition, he is able to view the live version of what the farmer describes at will; he needs only shift his head to the adjacent screen.

The above can also be applied to existing documentaries, utilizing their extra footage for the additional screens.

Other aspects such as screenplay format are executed as described in the Narrative AVM chapter and in Post Production below.

### Active-View Advertising Videos

Like narrative videos, AVMT ads use multiple screens to create an interactive viewing experience. All processes (from script to completion) are the same as the description of narrative/entertainment videos above, as well as the description of Post Production below. Advertisement videos vary in their application: Rather than be used solely for entertainment purposes, the multiple screens of an AVMT ad can be used to provide further information on an advertised product FIG. 6, 601, 602, as well. The overall viewing experience stimulates further involvement from the viewer. This connection with the ad and product therefore improves takes the effectiveness of an ad to a higher level than a conventional ad.

### Active-View Training and Educational Videos

Conventional educational videos are either scripted or are similar to documentary films in which unscripted footage is also gathered. AVMT training/educational videos, both scripted (like an entertainment video) and unscripted (like a documentary), are filmed as multiple, parallel sections. The content of each section is designed to enrich the other sections and maximize accessibility to related content at any given moment. Examples for this: A man explains the solar system in one screen, while images matching his description are shown on adjacent screens; a martial arts teacher explains a technique FIG. 7 704 on one screen 701 while different angles of the demonstration of the technique 705, 706 are shown in parallel screens 702, 703. Other aspects such as screenplay format are executed as described in the Narrative AVM chapter and in Post Production below.

### Medical/Therapeutic Videos

As with educational videos (above), the multiple screens of AVMT Medical/Therapeutic videos maximize the accessibility of related content at any given moment. The script is therefore designed to maximize accessibility to relating content, as well as enrich the video's content and make it more engaging by making multiple relating threads available. Other aspects such as screenplay format are executed as described in the Narrative AVM chapter and in Post Production below.

### Active-View Movie Post-Production Phase: Video Stream Processing and Playing

Once all AVMT Video streams are shot and edited, audio and visual effects are added and the conventional post production process is completed, the streams are processed by the Active-View Compiler (software) FIG. 1, 209 and formatted and optimized for viewing in the AVMT Player 207. The AVMT player plays the AVMT Video file and gives control over its channels to the VR device FIG. 8, 206 or other controller used by the viewer 208.

The AVMT Player associates the movements and direction of the VR headset (or buttons of controller) with the video's screens 701, 702, 703. When shifted by the user's head in a specified direction such as the headset's center FIG. 9 702, right, 701 or left, 703, the video and sound 801, 802, 803, of that section are accessed. When the VR headset is shifted to another direction, the video and sound seamlessly fade 804, 805 to that direction's video and soundtrack. The sound is recorded in stereo, and fades in (rises in volume) starting from the direction that it is shifted in (e.g., when shifting from the screen on the headset's left 703 to the screen in the center 702, the sound rises from the left) and expanding to the other side. Likewise, the program's seamless interface means that the VR Headset's motion (or other device, set to “scrolling” FIG. 11) does not ‘select’ a new screen; instead, the videos are positioned in their assigned directions and the VR Headset 206 shifts between them linearly 1101. For example, with Screen One 702 in the headset's center, Screen Two 701 on its right and Screen Three 703 on its left in FIG. 8, 11, to get from Screen Two 701, (headset right) to Screen Three (703, headset left) a viewer wearing a headset must shift his head to the left, passing Screen One (702, headset's center) on his way. This method of screen selection can also be achieved using a specialized or existing controller —which serves to shift the field of view between screens using buttons instead of headset motion. Alternately, screens can be ‘switched’ FIG. 12 instead of ‘scrolled’: Using a controller or the VR headset, a button or motion instantaneously makes the video cut between selected screens 701, 702, 703.

### AVMT Player—Software

As a specialized, multi-channeled file, an AVMT Video file requires a special Active-View Video Player (FIG. 1 207) to play it. The player plays the video and provides the user interface with the video. Supporting platforms for the player include computers, mobile devices and a dedicated player (hardware, below). The player allows users to play, stop, rewind and fast-forward the video. Other options include the ability to assign directions for each of an AVMT video's screens. It can also incorporate additional options such as adding text/video comments at certain points of the film to be shared online, in social media websites etc.

### AVMT Player—Hardware

Along with the option of playing the AVMT file on a computer, the AVMT Video file can also be played on a dedicated player which connects to a VR Headset, or a screen. The controller features a wireless internet connection to an online AVMT movie sales/rental service (‘online store’). It can also include non-AVMT movies and videos, as well as access to streaming video websites. Controls of the player can be achieved by using an accompanying controller, or a combination of this controller and the VR headset's head motion for screen switching, playing, and controlling.

### Active-View Movie Distribution

The complete Active-View movie is distributed on different platforms such as a dedicated website, an existing online movie sales/rental service, or a physical copy can be distributed to both movie and video game physical stores.

### Active-View Movie Development

In order to perfect the methods of creating effective AVMT Video, an AVMT tracking program is created which records the history of motions of the headset or channel selections of the user throughout a video FIG. 13. This record aids in the development process: By following where viewers decided to switch screens 1309, an AVMT Video can be tested for effectiveness, and specific cues and methods for causing viewers to explore other screens or channels can be observed and analyzed. This tracking program is also a feature of the AVMT player that can be used by a viewer for revisiting the movie as he experienced it in a specific viewing session.

The invention referred to herein as the Active-View Movie Technology (AVMT) is a method for creating an interactive video with applications including but not limited to:
Narrative content films (including movies, TV shows, music videos and other entertainment videos);
Documentary films;
Advertising videos;
Training and educational videos;
Medical and therapeutic videos;
Each of the above in a group-viewing setting.

In this video format, viewers are able to follow relating interchangeable screens throughout a video at will. In this way, viewers are no longer limited to a single, linearly unfolding video, and instead viewers take an active part in the video's unfolding. Viewers are free to explore multiple, interrelated channels or ‘screens’ of interconnected content, effectively creating their own personalized viewing experience in the process. Different devices or platforms are offered to display and select AVMT Video content: The first of these is a Virtual Reality (VR) Headset such as the Oculus Rift™ VR Headset, in combination with a dedicated player platform (hardware and software) or the same with a screen replacing the VR Headset. Other options include Computers, mobile devices, etc.

In the field of entertainment, documentary (and advertising), the viewer is more engaged than ever before in the video's content, since the viewer is an active participant in the formation of the story. In medical, therapeutic, educational and training videos, the video's multi-screened nature maximizes accessibility to related content, accelerates learning and training, and improves the effectiveness of therapeutic videos, while also creating a more engaging and enjoyable experience overall.

In the field of entertainment, documentary and advertising, the viewer is more engaged than ever before in the video's content, since the viewer is an active participant in the formation of the story. In medical, therapeutic, educational and training videos, the video's multi-screened nature maximizes accessibility to related content, accelerates learning and training, and improves the effectiveness of therapeutic videos, while also creating a more engaging and enjoyable experience overall.

While embodiments of the invention herein disclosed have been described and illustrated by means of specific applications such as, narrative and documentary movies, training/education videos, medical/therapeutic, and advertisement/promotions applications, numerous applications and variations can be made thereto by those skilled in various arts and technologies without departing from the scope of the above preferred embodiments.

What is claimed is:

1. A method of producing an interactive video by creating a single video file comprising multiple interconnected and individually scripted video channels all telling one story or presenting one topic and making all channels selectable by the viewer at any given moment thereby creating a customizable viewing experience shaped by the viewer's choices of channels throughout the video.

2. A method of scripting and synchronizing an interactive multi-channel video, comprising the following steps:
a. designing a story or script telling one story or presenting one topic in multiple parallel script sections each describing the content of its respective channel, or reformatting an existing story into the form of multiple parallel threads by dividing its content into multiple parallel channels.
b. writing the multiple sections of a script in a way which indicates their parallel synchronization, including writing sections in parallel columns on one script page wherein the parallel column lines indicate actions happening simultaneously on their respective screens; or writing the different script sections as separate scripts and inserting written time counters (hours, minutes and seconds) in each script page, scene or event as needed, or describing key simultaneous moments of additional script sections in each section to synchronize parallel action.
c. devising cues for alerting the viewer to key events happening in adjacent screens, including:
devising events or disturbances taking place on one screen relating to the content of another screen(s) to pull viewer attention to the second screen.
creating sound cues, light signals, arrows etc. recommending a shift between screens.
creating musical cues, such as the playing of a specific theme assigned to a specific character, location, etc. to draw attention to their corresponding screens.

3. A method of filming footage for an Active-View Movie Technology video comprising:
a. creating the illusion of live, continuous action: a cinematography technique incorporating prolonged continuous filming and minimizes cutting between shots
b. producing footage easily comprehensible to the viewer: a cinematography technique which minimizes use of ‘cuts’ between camera shots and minimizes camera motion and close-ups, intentionally producing a consistently simplistic video
c. filming multiple interconnected video threads in a predetermined synchronization with each other and
d. incorporating 3D, 360° footage into an Active-View Movie.

4. A method of choosing which of the multiple channels (“screens”) to follow at any moment and switching from screen to screen comprising:
a. using a Virtual Reality headset's motion to switch channels or to shift field of view between screens—the latter when screens are aligned and ‘positioned’ side by side in the headset's field of view;
b. using a specialized controller to switch channels or to shift field of view between screens—the latter when screens are aligned and ‘positioned’ side by side in the display's field of view: using a button, switch, touchpad, motion controller, voice, etc.;
c. using existing controllers to switch, or shift field of view between screens—the latter when screens are aligned and ‘positioned’ side by side in the display's field of view: mouse, keyboard, remote control, game system controller, etc.

5. A method of compiling multiple videos into a single Active-View Movie Technology (AVMT) file, processing and preparing the file for playing on a platform which enables the viewer to shift between the different video channels at will, comprising:
a. a computer program integrating multiple 2D/3D/360° videos into a single Active-View Movie Technology (AVMT) video file, assigning different video streams to different channels, and configuring video and audio channels for viewing on various platforms;
b. a computer program utility creating a ‘fade zone’ between channels (screens) for display on the Virtual Reality headset. In a setting when screens are aligned and ‘positioned’ side by side in a Virtual Reality headset's field of view, each video screen fades into the next;
c. assigning multiple Active-View Movie Technology screens to the user-operated controls by utilizing the application programming interface language native to the video-playing platform hardware such as the Oculus Rift™ Virtual Reality (VR) Headset.
d. assigning the different AVMT Video channels' sound tracks by an audio processing module to their respective screens; including a ‘sound fade zone’ between adjacent screens wherein sound of both screens is heard but lowered when the field of view is positioned between them, when selecting channels in using a scrolling field of view;
e. configuring and optimizing sound tracks for their assigned screens using an audio processing module; wherein the stereo sound fades from screen to screen according to the viewer's controller direction of motion: when scrolling from a Right side screen to a Left side screen—volume on the Left screen rises from the Viewer's left side/left ear to his right side (right ear), while simultaneously Right screen volume lowers from the viewer's left side (left ear) to his right side/right ear, and vice versa in opposite motion direction between screens;
f. separately controlling elements of AVMT soundtracks using an audio processing module to minimize disruption when switching between screens: sustaining some elements such as music even when screens are changed; or muting, lowering and raising the volume of specific elements as needed.
g. using specialized software to compile all completed video and audio files of each thread into a single Active-View Movie Technology Video file playable with specialized software run on a computer, mobile device or specialized hardware connected to a screen or Virtual Reality headset.

6. A method for playing and controlling Active-View Movie Technology Video files comprising multiple channels, using a specialized player hardware and software, wherein selection of the video's channels is made by a Virtual Reality Headset or other controller, and incorporating additional controls such as:
a. play/pause/stop controls—wherein all channels play, pause or stop;
b. fast-forward and rewind controls—all channels fast forward or rewind;
c. screen zooming, controlled by the VR headset's forward/backward motion, or buttons or switches on other platforms/controllers;
d. playing speed;
e. sound volume;
f. menu access;
g. chapter selection;
h. screen calibration: size, position.
i. recording utility: viewer channel changes are recorded.
